(19) United States
(12) Patent Application Publication
(10) Pub. No.: US 2015/0012861 A1
(43) Pub. Date: Jan. 8, 2015

(54) SYNCING CONTENT CLIPBOARD

(71) Applicant: Dropbox, Inc., San Francisco, CA (US)

(72) Inventor: Evgeny Loginov, Palo Alto, CA (US)

(21) Appl. No.: 13/934,103

(22) Filed: Jul. 2, 2013

(51) Int. Cl. G06F 3/0484

(52) U.S. Cl. CPC G06F 3/0484
USPC 715/770

(57) ABSTRACT

Various embodiments provide a method of providing a clipboard that is available to a user across multiple devices, regardless of the particular semantics governing a particular environment or computing device. In particular, a user having an account linking multiple computing devices can, in one example, sync items stored to a clipboard across each device, thereby enabling the user to cut/copy an item on one device and paste the item on another.

### TECHNICAL FIELD

The present technology pertains to copying items to a clipboard, and more specifically pertains to enabling users to sync items in a clipboard across multiple computing devices.

### BACKGROUND

Cut, copy, and paste are operations that enable a user to transfer text, data, files, or objects from a source to a destination. A cut operation removes selected data from its original location (source), while a copy command creates a duplicate of the selected data. Upon either cutting or copying, the selected data is stored to a clipboard where the data is available to a user to insert the selected data by performing a paste operation.

In order to perform this operation, a user first selects or highlights text or a file, typically by dragging over the text or file name with the pointing-device or holding down the Shift key while using the arrow keys to move a text cursor. Accordingly the user performs the cut operation by either left-clicking a mouse to bring up a menu or using a key combination command (i.e., Ctrl+x) to cut the selected text. Once the text or file is cut, the text or file disappears from its original location (source) as it is stored to the clipboard. Copied files are similar to cut files except that the text or file does not disappear from its original location (source).

Accordingly, the paste operation inserts the text or file stored on the clipboard at a destination chosen by the user. In this instance, the user can chose a desired insertion point and either left-click to bring up the menu or by using a key combination command (i.e., Ctrl+v) to paste the text or file into the desired location.

The clipboard can be used for short-term data storage or data transfer between documents or applications, via the cut, copy, and paste operations. Commonly, the clipboard is part of a GUI environment and is usually implemented as an anonymous, temporary data buffer that can be accessed from most, if not all, programs within a computing device. A typical application accesses clipboard functionality by mapping a user input to an interface.

The semantics governing the functionality of the clipboard can often vary from one computing environment or device to another, and can also vary between versions of the same system. In some instances, the semantics can be changed by different programs or by a user's preferences. Such an inconsistency can often be frustrating when switching between environments or devices with different clipboard semantics. Further, when copying or cutting an item to the clipboard, users are limited to pasting that item to a destination within the same environment or on the same computing device from which the item was cut/copied. As more users start to utilize more than one computing device, it can be advantageous to provide a clipboard that is available to a user across all of a user's associated devices regardless of the particular semantics governing a particular environment or computing device.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In at least one embodiment, a user can store and modify a content item from multiple computing devices. Each of the computing devices, in this example, locally stores a copy of the content item and communicates with an online content management system to maintain a universal copy of the content item locally stored on each device. A cut or copy operation performed by the user on a first computing device is detected. In this example, the cut or copy operation stores data for an item to a clipboard of the first computing device. Accordingly, the online content management system can obtain the data for the item from the clipboard of the first computing device. Upon obtaining the data for the item, the online content management system can update the clipboard, or some other temporary storage, for each computing device associated with the user's account to enable the user to transfer the item, by performing a paste operation, to an application or content item on a second computing device.

In at least one embodiment, each computing device includes a client-side application that communicates with the online content management system to sync data stored locally on each computing device with data stored with the online content management system. Further, obtaining the data for the item stored to the clipboard of the first computing device may include the client-side application of the first computing device sending the data for the item to the online content management system. Accordingly, updating the clipboard of each of each computing devices may include locally syncing the clipboard of each computing device. In this example, the first computing device and the second computing device can be associated with a different operating system or a different device platform.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A-1E shows an exemplary process of a user copying data on a first device and pasting the data on a second device in accordance with at least one embodiment;

FIG. 2 shows an example process in accordance with at least one embodiment;

FIG. 3 shows an example process in accordance with at least one embodiment;

FIG. 4 shows an exemplary configuration of devices and a network in accordance with the invention;

FIG. 5A shows a conventional system bus computing system architecture; and

FIG. 5B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The disclosed technology addresses the need in the art for providing a clipboard that is available to a user across all of a user's associated devices, regardless of the particular semantics governing a particular environment or computing device. In particular, a user having an account linking multiple computing devices can, in one example, sync items stored to a clipboard across each device, thereby enabling the user to cut/copy an item on one device and paste the item on another.

For example, an online content management system can enable a user to upload and save a content item to one or more databases in a cloud computing environment. The online content management system can store a universal copy of the content item and enable the user to modify the content item from any number of computing devices through, for example, a personalized account. Each of the user's computing devices, in this example, can include a client-side application that communicates with the online content management system to sync a copy of the content item stored locally on each computing device with the universal copy of the content item stored with the online content management system. Accordingly, the client-side application may also communicate with the online content management system to maintain a universal clipboard across each of the user's devices.

Various other functions and advantages are described and suggested below as may be provided in accordance with the various embodiments.

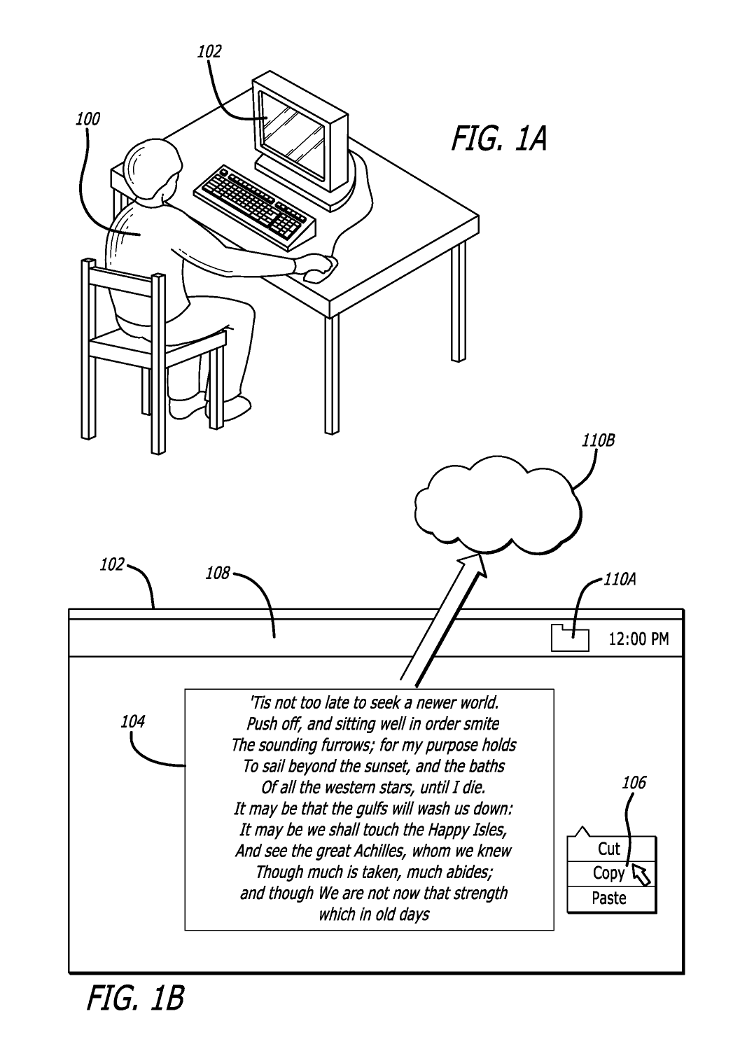

FIGS. 1A-1E show an example of user 100 cutting or copying text from first computing device 102 and pasting the text to second computing device 112, in accordance with at least one embodiment. In this example, FIG. 1A shows user 100 sitting and working with first computing device 102, which, in this example, is a desktop computer. Accordingly, FIG. 1B shows text 104 displayed on screen shot 108 of first computing device 102. In this example, text 104 is copied by user 100 by first selecting or highlighting text 104 and subsequently left-clicking the mouse of computing device 102 to bring up menu 106. Upon selecting copy on menu 106, text 104 will be copied and stored to a short-term storage repository, such as a clipboard (not shown). If, however, user 100 elects to cut text 104 via menu 106, text 104 will be removed from display on screen shot 108 as it is stored to the clipboard.

In this example, user 100 has an account with online content management system 110B, which can enable user 100 to upload and save content items, such as documents, spreadsheets, pictures, or any other file, to one or more databases in a cloud computing environment. In various implementations, online content management system 110B may store a universal copy of a content item and enable user 100 to modify the content item from any number of computing devices through their account. In this example, each computing device (102, 112) can include client-side application 110A that communicates with online content management system 110B to sync a copy of the content item stored locally on each computing device (102, 112) with the universal copy of the content item stored with online content management system 110B. Client-side application 110A, in this example, can also communicate with online content management system 110B to maintain a universal clipboard across each computing device (102, 112) or some other temporary storage other than a local clipboard associated with each computing device (102, 112).

Accordingly, once user 100 cuts or copies text 104, data associated with text 104 can be obtained by online content management system 110B by, for example, computing device 102 syncing content of the clipboard to online content management system 110B, or online content management system 110B pulling the data for text 104 from the clipboard. In one example, client-side application 110A can access clipboard functionality by mapping user inputs associated with the cut or copy operation. In another example, a notification may be sent to client-side application 110A that an item has been stored in the clipboard for retrieval at least when an item is stored or as user 100 executes an associated command.

Once user 100 has copied text 104 and data for the same has been provided to online content management system 110B, user 100 may paste the item to second computing device 112, as shown in FIG. 1C. Accordingly, FIG. 1D shows the flow of data for text 104 from online content management system 110B to second computing device 112. In one example, data for text 104 can sync with second computing device 112 when second computing device 112 is powered on or becomes active, such as when it is woken up from a sleep mode. For example, when second computing device 112 is woken up, it could check to see if any updates are available for content items, clipboard items, and the like, from online content management system 110B.

FIG. 1D further shows second computing device 112 as a tablet computer where user 100 has provided a touch input to a word processor application in order bring up menu 114 to paste text 104. Accordingly, FIG. 1E shows second computing device 112 after user 100 has selected paste on menu 114 to paste text 104 into the word processor application. Similarly, user 100 could subsequently paste the same passage into a text message or email on their smartphone. Further, user 100 could also subsequently cut or copy a second item on computing device 112, which would update the clipboard once more, as described above, and make the second item available for pasting on at least computing device 102.

In at least one embodiment, data for copied text 104 could expire after a determined amount of time if a user's computing device has not synced, such as by connecting to a network. Further, a user could specify which devices could receive the data for copied text 104. In one example, a user could specify a device at the time the item is copied. In this example, the user could have dedicated commands for sending/syncing the data for copied text 104 to a particular device or subset of devices or the user could be prompted with a pop including each of their devices to select which device(s) will receive the data for copied text 104. In another example, the user could specify and store user preferences specifying which devices associated with their account with the online content management system, if not all, receive clipboard sync updates.

Further, attempting to cut or copy paste an item while operating a remote desktop can be a frustrating experience. For example, a user operating a remote desktop (virtual operating system) from a first computing device on a second computing device (native operating system) will often want to cut or copy an item from an application running on the first device and paste the item to an application running on the second device and vice versa. This, however, is not possible because each device is operating its own independent clipboard. This can be frustrating because users often forget about the division between these two devices. Therefore, in at least one embodiment, upon syncing the item from an application running on the second device, the item can sync with the online content management system, which can then make the item available for pasting on the first device (and vice versa).

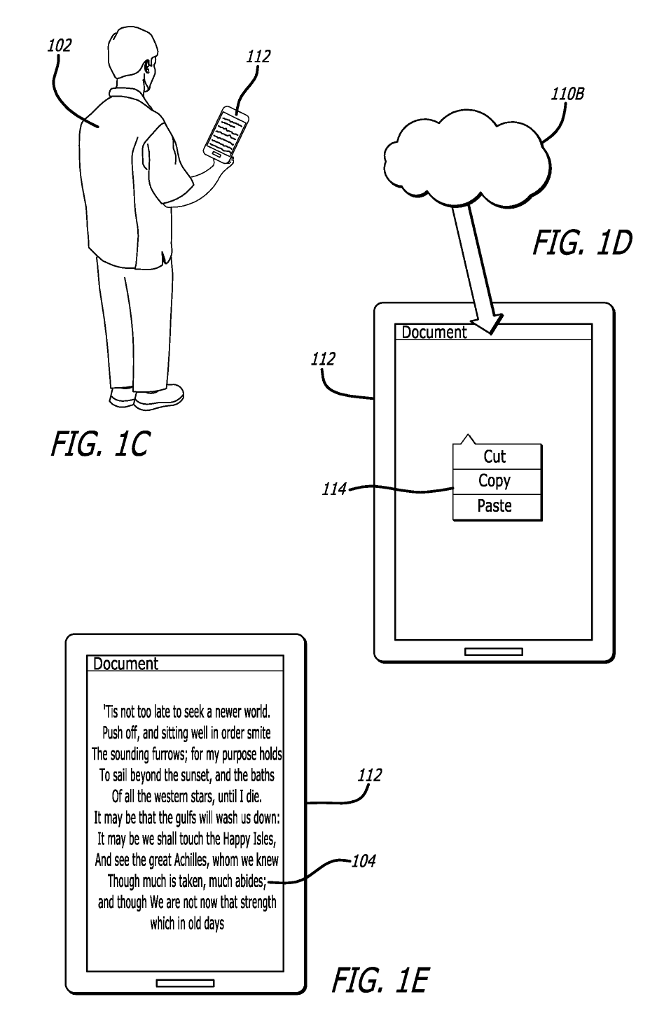

FIG. 2 illustrates an example process 200 for syncing a clipboard across multiple devices, in accordance with various embodiments. It should be understood that, for any process discussed here, there can be additional, fewer, or alternative steps performed in similar or alternative orders, or in parallel, within the scope of the various embodiments unless otherwise stated.

In this example, a user is enabled 202 to store and modify a content item from a number of computing devices through an account with an online content management system. Here, each of the computing devices can include a client-side application that communicates with the online content management system to sync a copy of the clipboard, or data/items associated with the clipboard, stored locally on each computing device with data stored with the online content management system.

In this example, a user has cut or copied an item to the clipboard, which has been detected by the client-side application 204. In this example, data associated with the item stored or copied to the clipboard is obtained 206 by the online content management system. Accordingly, once the online content management system obtains the data for the item stored to the clipboard of the first computing device, clipboards of the computing devices associated with the user's account can be updated 208. Various other approaches can be used as well as discussed or suggested elsewhere herein.

Further, upon obtaining data for the item, the online content management system could update some other temporary storage other than a general clipboard that is automatically used by each application. For example, there could be a dedicated sync clipboard associated with the online content management system. In this example, the data could be copy and pasted using a special set of key commands by a user for this dedicated purpose. Accordingly, there could be two sets of commands for pasting an item; a first set associated with pasting an item from a local clipboard and a second set associated with pasting items from a sync clipboard or temporary storage associated with the online content management system.

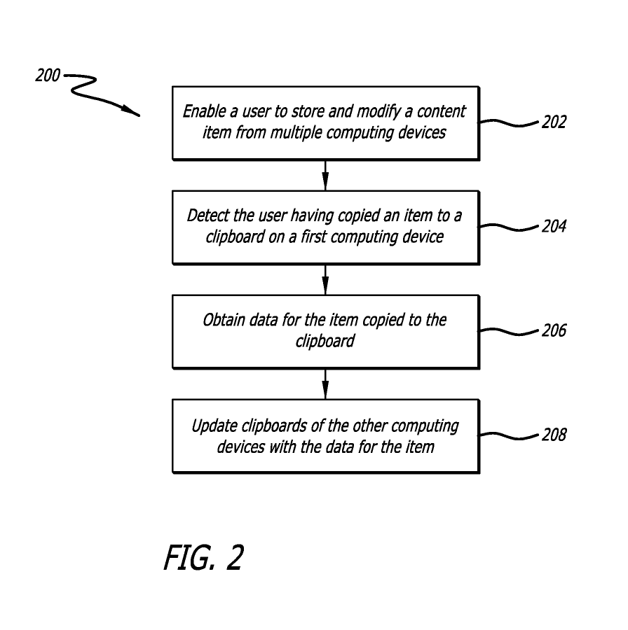

FIG. 3 illustrates another example process 300 for syncing a clipboard across multiple devices, in accordance with various embodiments. As above, it should be understood that, for any process discussed here, there can be additional, fewer, or alternative steps performed in similar or alternative orders, or in parallel, within the scope of the various embodiments unless otherwise stated.

In this example, a first and a second computing device are associated 302 with each other via an account with an online content management system. In this example, a first item saved to a first repository (short-term temporary storage) on a first computing device is identified 304. Accordingly, the first computing device syncs with the online content management system, which obtains 306 data for the first item. Accordingly, once the online content management system obtains the data for the item stored to the first repository, repositories of computing devices associated with the user's account are updated 308. In this example, a second item saved to a second repository on a second computing device is subsequently identified 310. Similarly described above, the second computing device syncs with the online content management system, which obtains 312 data for the second item. Accordingly, the first repository of the first computing device, as well as other devices associated with the user's account, are updated 314. Various other approaches can be used as well as discussed or suggested elsewhere herein.

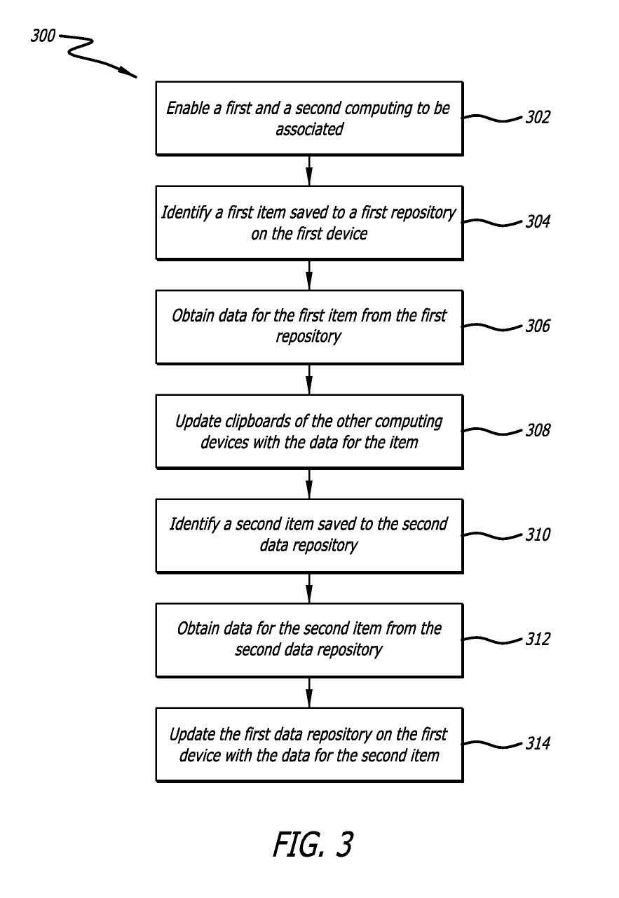

An exemplary system configuration 400 for sharing documents and providing synchronized comments among users for the shared documents is shown in FIG. 4, wherein computing devices communicate via a network for purposes of exchanging content and other data. The system can be configured for use on a wide area network such as that illustrated in FIG. 4. However, the present principles are applicable to a wide variety of network configurations that facilitate the intercommunication of electronic devices. For example, each of the components of system 400 in FIG. 4 can be implemented in a localized or distributed fashion in a network.

In system 400, a user can interact with content management system 406 through computing devices 402₁, 402₂, . . . , 402ₖ (collectively “402”) connected to network 404 by direct and/or indirect communication. Content management system 406 can support connections from a variety of different computing devices, such as desktop computers; mobile computers; mobile communications devices, e.g. mobile phones, smart phones, tablets; smart televisions; set-top boxes; and/or any other network enabled computing devices. Computing devices 402 can be of varying type, capabilities, operating systems, etc. Furthermore, content management system 406 can concurrently accept connections from and interact with multiple computing devices 402.

A user can interact with content management system 406 via a client-side application installed on computing device 402ᵢ. In some embodiments, the client-side application can include a content management system specific component. For example, the component can be a stand-alone application, one or more application plug-ins, and/or a browser extension. However, the user can also interact with content management system 406 via a third-party application, such as a web browser, that resides on computing device 402ᵢ and is configured to communicate with content management system 406. In either case, the client-side application can present a user interface (UI) for the user to interact with content management system 406. For example, the user can interact with the content management system 406 via a client-side application integrated with the file system or via a webpage displayed using a web browser application.

Content management system 406 can make it possible for a user to store content, as well as perform a variety of content management tasks, such as retrieve, modify, browse, and/or share the content. Furthermore, content management system 406 can make it possible for a user to access the content from multiple computing devices 402. For example, computing device 402ᵢ can upload content to content management system 406 via network 404. The content can later be retrieved from content management system 406 using the same computing device 402ᵢ or some other computing device 402ⱼ.

To facilitate the various content management services, a user can create an account with content management system 406. The account information can be maintained in user account database 450. User account database 450 can store profile information for registered users. In some cases, the only personal information in the user profile can be a username and/or email address. However, content management system 406 can also be configured to accept additional user information.

User account database 450 can also include account management information, such as account type, e.g. free or paid; usage information, e.g. file edit history; maximum storage space authorized; storage space used; content storage locations; security settings; personal configuration settings; content sharing data; etc. Account management module 424 can be configured to update and/or obtain user account details in user account database 450. The account management module 424 can be configured to interact with any number of other modules in content management system 406.

An account can be used to store content, such as digital data, documents, text files, audio files, video files, etc., from one or more computing devices 402 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 460. Content storage 460 can be a storage device, multiple storage devices, or a server. Alternatively, content storage 460 can be a cloud storage provider or network storage accessible via one or more communications networks. Content management system 406 can hide the complexity and details from computing devices 402 so that computing devices 402 do not need to know exactly where the content items are being stored by content management system 406. In one variation, content management system 406 can store the content items in the same folder hierarchy as they appear on computing device 402ᵢ. However, content management system 406 can store the content items in its own order, arrangement, or hierarchy. Content management system 406 can store the content items in a network accessible storage (SAN) device, in a redundant array of inexpensive disks (RAID), etc. Content storage 460 can store content items using one or more partition types, such as FAT, FAT32, NTFS, EXT2, EXT3, EXT4, ReiserFS, BTRFS, and so forth.

Content storage 460 can also store metadata describing content items, content item types, and the relationship of content items to various accounts, folders, or groups. The metadata for a content item can be stored as part of the content item or can be stored separately. In one variation, each content item stored in content storage 460 can be assigned a system-wide unique identifier.

Content storage 460 can decrease the amount of storage space required by identifying duplicate files or duplicate segments of files. Instead of storing multiple copies, content storage 460 can store a single copy and then use a pointer or other mechanism to link the duplicates to the single copy. Similarly, content storage 460 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 406 can be configured to support automatic synchronization of content from one or more computing devices 402. The synchronization can be platform agnostic. That is, the content can be synchronized across multiple computing devices 402 of varying type, capabilities, operating systems, etc. For example, computing device 402ᵢ can include client software, which synchronizes, via a synchronization module 432 at content management system 406, content in computing device 402ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 406. Conversely, the background process can identify content that has been updated at content management system 406 and synchronize those changes to the local folder. The client software can provide notifications of synchronization operations, and can provide indications of content statuses directly within the content management application. Sometimes computing device 402ᵢ may not have a network connection available. In this scenario, the client software can monitor the linked folder for file changes and queue those changes for later synchronization to content management system 406 when a network connection is available. Similarly, a user can manually stop or pause synchronization with content management system 406.

A user can also view or manipulate content via a web interface generated and served by user interface module 422. For example, the user can navigate in a web browser to a web address provided by content management system 406. Changes or updates to content in the content storage 460 made through the web interface, such as uploading a new version of a file, can be propagated back to other computing devices 402 associated with the user's account. For example, multiple computing devices 402, each with their own client software, can be associated with a single account and files in the account can be synchronized between each of the multiple computing devices 402.

Content management system 406 can include a communications interface 420 for interfacing with various computing devices 402, and can interact with other content and/or service providers 409₁, 409₂, . . . , 409ₖ (collectively “409”) via an Application Programming Interface (API). Certain software applications can access content storage 460 via an API on behalf of a user. For example, a software package, such as an app on a smartphone or tablet computing device, can programmatically make calls directly to content management system 406, when a user provides credentials, to read, write, create, delete, share, or otherwise manipulate content. Similarly, the API can allow users to access all or part of content storage 460 through a web site.

Content management system 406 can also include authenticator module 426, which can verify user credentials, security tokens, API calls, specific computing devices, and so forth, to ensure only authorized clients and users can access files. Further, content management system 406 can include analytics module 434 module that can track and report on aggregate file operations, user actions, network usage, total storage space used, as well as other technology, usage, or business metrics. A privacy and/or security policy can prevent unauthorized access to user data stored with content management system 406.

Content management system 406 can include sharing module 430 for managing sharing content publicly or privately. Sharing content publicly can include making the content item accessible from any computing device in network communication with content management system 406. Sharing content privately can include linking a content item in content storage 460 with two or more user accounts so that each user account has access to the content item. The sharing can be performed in a platform agnostic manner. That is, the content can be shared across multiple computing devices 402 of varying type, capabilities, operating systems, etc. The content can also be shared across varying types of user accounts.

In some embodiments, content management system 406 can include a content item management module 428 for maintaining a content directory. The content directory can identify the location of each content item in content storage 460. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 406 can use the content path to present the content items in the appropriate folder hierarchy.

A content entry can also include a content pointer that identifies the location of the content item in content storage 460. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 430 can be configured to add a user account identifier to the content entry associated with the content item, thus granting the added user account access to the content item. Sharing module 430 can also be configured to remove user account identifiers from a content entry to restrict a user account's access to the content item.

To share content publicly, sharing module 430 can be configured to generate a custom network address, such as a uniform resource locator (URL), which allows any web browser to access the content in content management system 406 without any authentication. To accomplish this, sharing module 430 can be configured to include content identification data in the generated URL, which can later be used to properly identify and return the requested content item. For example, sharing module 430 can be configured to include the user account identifier and the content path in the generated URL. Upon selection of the URL, the content identification data included in the URL can be transmitted to content management system 406 which can use the received content identification data to identify the appropriate content entry and return the content item associated with the content entry.

In addition to generating the URL, sharing module 430 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 430 can be configured to change the value of the flag to 6 or true after generating a URL to the content item.

In some embodiments, sharing module 430 can also be configured to deactivate a generated URL. For example, each content entry can also include a URL active flag indicating whether the content should be returned in response to a request from the generated URL. For example, sharing module 430 can be configured to only return a content item requested by a generated link if the URL active flag is set to 6 or true. Thus, access to a content item for which a URL has been generated can be easily restricted by changing the value of the URL active flag. This allows a user to restrict access to the shared content item without having to move the content item or delete the generated URL. Likewise, sharing module 430 can reactivate the URL by again changing the value of the URL active flag to 6 or true. A user can thus easily restore access to the content item without the need to generate a new URL.

While content management system 406 is presented with specific components, it should be understood by one skilled in the art, that the architectural configuration of system 406 is simply one possible configuration and that other configurations with more or less components are also possible.

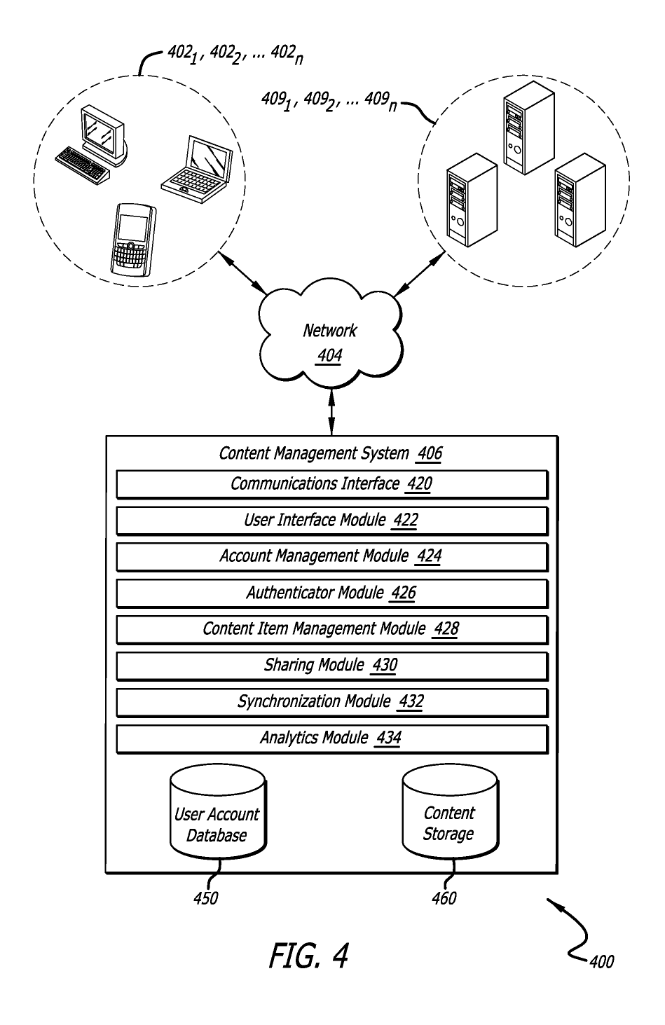

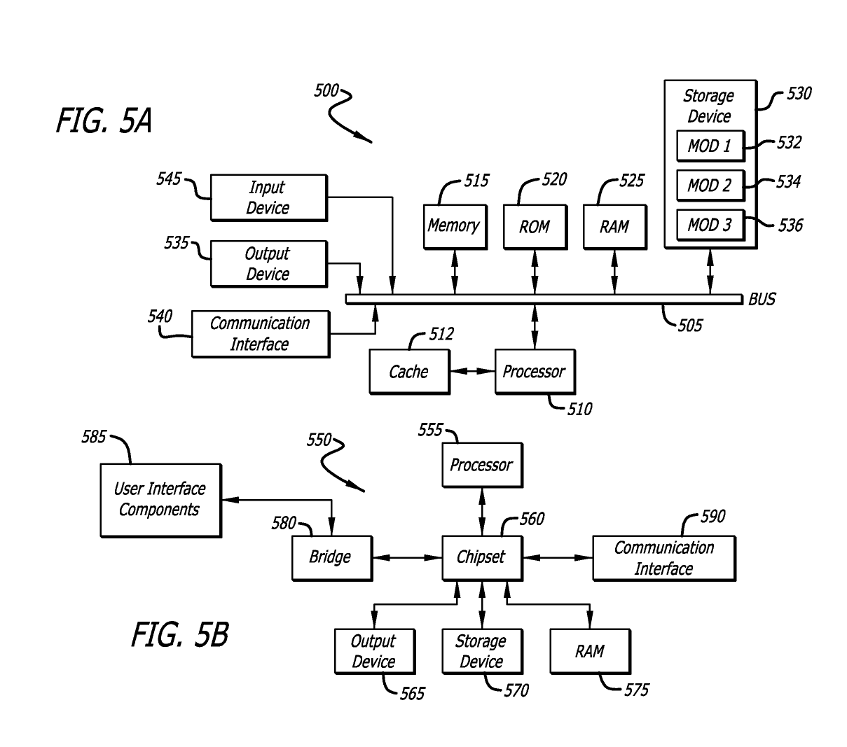

FIG. 5A, and FIG. 5B show exemplary possible system embodiments. The more appropriate embodiment will be apparent to those of ordinary skill in the art when practicing the present technology. Persons of ordinary skill in the art will also readily appreciate that other system embodiments are possible.

FIG. 5A shows a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B shows a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 550 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method, comprising:
under the control of one or more computer systems configured with executable instructions,
detecting one of a cut or copy operation on a first computing device, the cut or copy operation storing data for an item to a clipboard of the first computing device;
obtaining, by an online content management system, the data for the item stored to the clipboard of the first computing device; and
updating, by the online content management system, a clipboard of a second computing device with the data for the item, wherein the data is available for performing a paste operation, to at least one of an application or content item on the second computing device.

2. The computer-implemented method of claim 1, wherein the first computing device and the second computing device have at least one of a different operating system or a different device platform.

3. The computer-implemented method of claim 1, wherein each of the first computing device and the second computing device includes a client-side application that communicates with the online content management system to sync data stored locally on the plurality of computing devices with data stored with the online content management system.

4. The computer-implemented method of claim 3, wherein obtaining the data for the item stored to the clipboard of the first computing device includes:
sending, by a client-side application on the first computing device, the data for the item to the online content management system.

5. The computer-implemented method of claim 3, wherein updating the clipboard of the second computing device with the data for the item includes:
syncing the clipboard of each of the plurality of computing devices.

6. The computer-implemented method of claim 3, wherein updating the clipboard of the second computing device with the data for the item includes:
sending, by the online content management system, the data for the item to the respective client-side application on the second computing device for local storage.

7. A non-transitory computer-readable storage medium storing instructions that, when executed by at least one processor, cause a computing device to:
enable a first computing device and a second computing to be associated with an account of an online content management system;
identify a first item saved to a first short-term data repository on the first computing device;
obtain data for the first item from the first short-term data repository;
update a second short-term data repository on the second computing device with the data for the first item.

8. The non-transitory computer-readable storage medium of claim 7, wherein obtaining the data for the first item includes:
sending, by a client-side application on the first computing device associated with the online content management system, the data for the first item to the online content management system.

9. The non-transitory computer-readable storage medium of claim 7, wherein the instructions that, when executed by at least one processor, cause a computing device to:
identify a second item saved to the second short-term data repository;
obtain data for the second item from the second short-term data repository;
update the first short-term data repository on the first computing device with the data for the second item.

10. The non-transitory computer-readable storage medium of claim 9, wherein the second item overwrites the first item saved in the second short-term data repository.

11. The non-transitory computer-readable storage medium of claim 9, wherein the first short-term data repository is a first clipboard and the first item is saved to the clipboard by at least one of a cut or copy operation performed by a user.

12. The non-transitory computer-readable storage medium of claim 11, wherein the second short-term data repository is a second clipboard enabling the user to transfer a copy of the first item to at least one of an application, content item, or folder on the second computing device by performing a paste operation.

13. The non-transitory computer-readable storage medium of claim 12, wherein the content item is at least one of a word processing document, a spreadsheet, a presentation, or an image.

14. The non-transitory computer-readable storage medium of claim 12, wherein the item is at least one of text or a file.

15. A computing system, comprising:
at least one processor; and
memory including instructions that, when executed by the processor, cause the computing system to:
detect an item stored, by a copy operation, on a clipboard of a first computing device;
obtain, by the computing system, data for the item; and
update, by the computing system, a clipboard of at least a second computing device with the data for the item in response to detecting the item stored on the clipboard of the first computing device.

16. The computing system of claim 15, wherein the instructions that, when executed by the at least one processor, further cause the computing system to:
enable a user to transfer a copy of the item, by performing a paste operation, to at least one of an application, content item, or folder on the at least a second computing device.

17. The computing system of claim 15, wherein the computing system enables at least one of storing or modifying a content item from the first computing device and the at least a second computing device, each computing device locally storing a copy of the content item and communicating with the computing system to maintain a universal copy of the content item locally stored on each computing device.

18. The computing system of claim 15, wherein the first computing device and the at least a second computing device have at least one of a different operating system or a different device platform.

19. The computing system of claim 15, wherein each of the first computing device and the at least a second computing device includes a client-side application that communicates with the computing system to sync data stored locally on the first computing device and the at least a second computing device with data stored with the computing system.

20. The computing system of claim 19, wherein obtaining the data for the item includes:
sending, by the client-side application on the first computing device, the data for the item to the computing system.
